(19) United States
(12) Patent Application Publication
(10) Pub. No.: US 2016/0031723 A1
(43) Pub. Date: Feb. 4, 2016

(54) WATER FILTRATION DEVICES AND METHODS

(71) Applicant: SEI Manufacturing, Inc., North Augusta, SC (US)

(72) Inventors: Lewis W. Roach, JR., North Augusta, SC (US); Bryan D. Brown, Evans, GA (US); Thomas F. Proctor, IV, North Augusta, SC (US)

(21) Appl. No.: 14/813,188

(22) Filed: Jul. 30, 2015

Related U.S. Application Data
(60) Provisional application No. 62/031,013, filed on Jul. 30, 2014.

(51) Int. Cl. C02F 1/28; B01D 35/30; B01D 29/56; B01D 37/02

(52) U.S. Cl. CPC C02F 1/286; B01D 37/02; B01D 35/30; B01D 29/56; C02F 2303/04

(57) ABSTRACT

A filter assembly includes a horizontally extending buoyant member and a filter panel that extends vertically from the buoyant member, the filter panel defining a tortuous path for passage of water and a surface area for biofilm growth and capture of particles in the biofilm, the filter panel being flexible from a neutral shape and position under force, and being resilient to return to the neutral shape and position by structural rigidity after cessation of the force. The titter panel includes multiple parallel sections defined between parallel vertically extending slits. The parallel sections are flexible permitting opening of the slits. A protective cover faces away from the buoyant member opposite a direction in which the filter panel extends. The filter panel is folded over the buoyant member and the cover is folded over the filter panel.

### CROSS-REFERENCE TO RELATED APPLICATION

This application claims the benefit of priority of U.S. provisional patent application No. 62/031,013, titled “WATER FILTRATION DEVICES AND METHODS,” filed on Jul. 30, 2014, which is incorporated herein in its entirety by this reference.

### TECHNICAL FIELD

The present disclosure relates to methods and devices for reducing particulate matter such as coliform bacteria, in bodies of water. More particularly, the present disclosure relates to filtering devices and methods in which unwanted particulate matter in water is trapped in biofilm grown on a filter material.

### BACKGROUND

Urbanization and concentrated agricultural activities result in increased levels of suspended solids and coliform bacteria in the world's water bodies. Remediation efforts of these issues include best management practices for storm water runoff. In some instances, suspended solids or colloidal particles that do not settle to the bottom of water by gravity contain coliform bacteria and other pathogens. High levels of suspended solids increase the turbidity of the water, thus restricting the depth that sunlight can penetrate, thus interrupting a natural mechanism by which sunlight kills bacteria. Direct filtering using small-pore filters results in rapid fouling of the filters.

Improved devices and methods for reducing suspended particles such as bacteria, in large volumes of water are needed.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

A filter assembly according to at least one embodiment includes: a horizontally extending buoyant member; and a filter panel that extends vertically from the buoyant member, the fitter panel defining a tortuous path for passage of water and a surface area for biofilm growth and capture of particles in the biofilm, the filter panel being flexible from a neutral shape and position under force, and being resilient to return to the neutral shape and position by structural rigidity after cessation of the force.

In at least one example, the filter panel includes multiple parallel sections defined between parallel vertically extending slits.

In at least one example, the parallel sections are flexible permitting opening of the slits.

In at least one example, the filter panel includes a distal end extending away from the buoyant member, and the slits extend from the distal end toward the buoyant member without reaching the buoyant member.

In at least one example, the filter panel includes a first layer and a second layer that extend vertically in the same direction from the buoyant member.

In at least one example, the first layer and the second layer are contiguous portions of a single sheet of material that defines the filter panel.

In at least one example, the single sheet of material is uniformly thick.

In at least one example, the single sheet of material is folded over the buoyant member.

In at least one example, a protective cover faces away from the buoyant member opposite a direction in which the filter panel extends from the buoyant member.

In at least one example, the filter panel is folded over the buoyant member and the cover is folded over the filter panel.

In at least one example, the filter panel has a fold, and the buoyant member has a fold that is nested with the fold of the filter panel.

In at least one example, the buoyant member includes a tubular core surrounding an interior channel.

In at least one example, a tensile line is disposed within and along the interior channel.

In at least one example, the tensile line has at least one end attached to at least one fixed structure near a body of water.

In at least one example, the filter panel includes multiple parallel sections defined between parallel vertically extending slits, and the multiple parallel sections vary in length as measured from the buoyant member.

In at least one example, the filter panel has a thickness of approximately 3.50 to 4.00 inches.

In at least one example, the filter panel has two layers, each having a thickness of approximately 1.75 to 2.00 inches.

In at least one example, the filter panel includes a non-woven pile of fibers.

In at least one example, the filter panel includes a material binding the fibers.

In at least one example, the fibers include 300-500 Denier (den) polymeric fibers.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 is a side elevation view of a filter assembly according to at least one embodiment.

FIG. 2 is a front elevation view of the filter assembly of FIG. 1.

FIG. 3 is an elevation view of a widened filter assembly deployed across and into a body of water according to at least one embodiment.

FIG. 4 is an overhead view of the filter assembly of FIG. 3.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

In at least one embodiment, a biologically activated filter assembly is deployed in a body of water. In at least one embodiment, the filter assembly construction includes a nonwoven polymeric substrate. When deployed in water, the filter material is colonized by bacteria present in the water. The colonizing bacteria secrete extracellular polymeric substance (EPS), which results in a sticky film, or “biofilm,” covering the fitter material. Particles targeted for capture are then incorporated into the biofilm via sorption, referring to both the mechanisms of absorption and adsorption. Target particles can include coliform bacteria, microbes and other materials. Coliform bacteria include many bacteria species and pathogens including, for example, fecal bacteria.

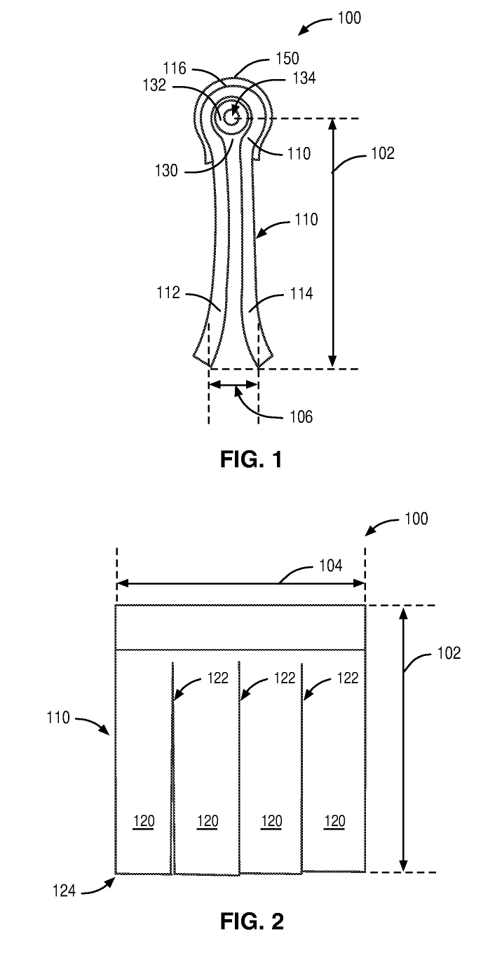

An exemplary filter assembly 100 according to at least one embodiment is illustrated in FIGS. 1-2. The filter assembly 100 includes a folded filter panel 110 extending generally in a single direction from a buoyant member 130. A protective cover 150 faces opposite the direction of extension of the filter panel. In use, the filter panel 110 will extend generally vertically downward into a body of water from the buoyant member 130, which will in that use extend horizontally across or near the top surface of the body of water assuring floatation of filter assembly 100. The cover 150 will face generally upward as a prophylactic protective top layer of the filter assembly 100.

Within these descriptions, in order to establish conventions for clarity: length 102 (FIGS. 1-2) of the filter assembly 100 refers to its vertical dimension or depth into a body of water from approximately the center of the buoyant member 130 to the distal lower end of the filter panel 110 width 104 (FIG. 2) of the filter assembly 100 refers to its horizontal dimension across a body of water from lateral side to side; and thickness 106 (FIG. 1) of the filter panel 110 refers to its horizontal dimension orthogonal to the length 102 and width 104, for example as taken along the flow direction of a body of water. Length, width, and thickness of individual elements of the filter assembly 100 in these descriptions refer to corresponding dimensions without reference numbers.

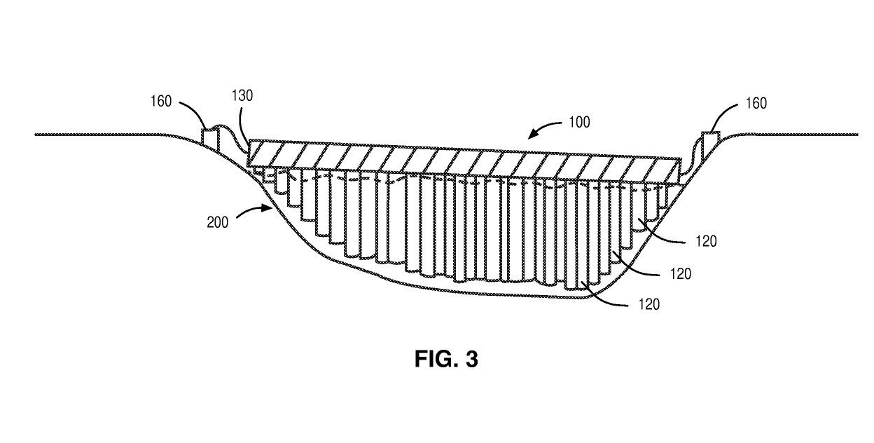

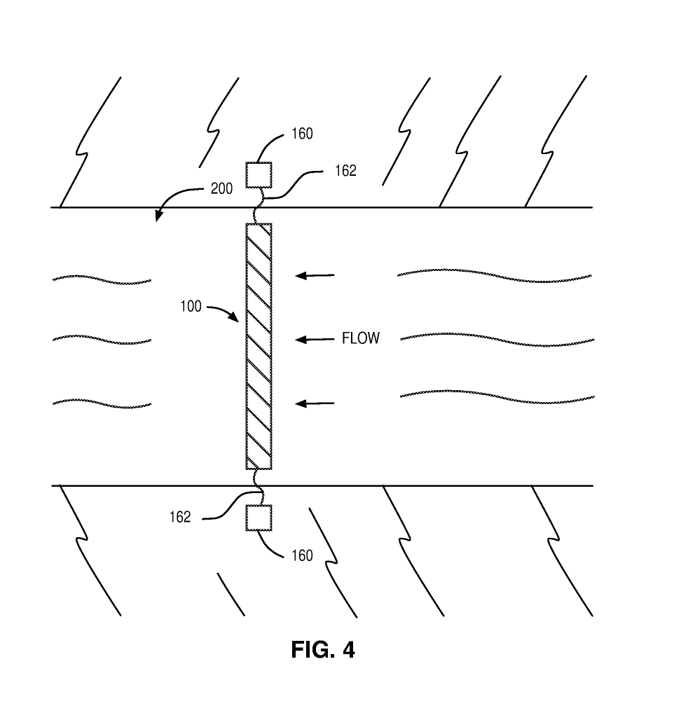

The buoyant member 130 in the illustrated embodiment includes a cylindrically shaped low-density tubular core 132 surrounding an interior channel 134 that extends the width of the buoyant member. A tensile line or rigid member may be extended through the interior channel 134 to connect together multiple filter assemblies 100, and to secure one or more of the filter assemblies 100 in a desired deployment configuration, for example crossing a body of water as shown in FIGS. 3 and 4.

In an exemplary construction, the tubular core 132 is constructed of low-density foam. For example, a marine grade poly-foam can be used. Shell layers may further line interior and exterior surfaces of the tubular core respectively along the interior channel 134 and along the radially outward surface of the tubular core 132 in contact with the folded filter panel 110. For example, an interior or exterior shell layer may be formed of a durable plastic such as high-density polyethylene (HDPE). In at least some embodiments, the tubular core 132 and/or any shell layers are at least semi-rigid to help maintain a generally linear arrangement of the filter assembly 100.

In the illustrated embodiment, the filter panel 110 (FIG. 1) has a doubled configuration folded around the tubular core 132 such that first and second layers 112 and 114 extend generally in a single direction from the buoyant member 130 and in use hang down from the buoyant member 130 into water. In the illustrated embodiment, the top fold of the filter panel 110 has an upper folded edge 116 retained within or covered by a slot defined in the down-facing side of the cover 150. The cover 150 is folded over the upper edge of the filter panel 100 and buoyant member 130, protecting particularly the upper folded edge 116 of the filter panel 100 from UV or other photolytic degradation.

In the illustrated embodiment, the first and second layers 112 and 114 are contiguous portions of a single sheet of uniformly thick material, and thus have the same thicknesses that sum to define the thickness 106 of the filter panel 110. Furthermore, the first and second layers 112 and 114 have equivalent lengths as measured from their junction at the upper folded edge 116, thus their extensions into the depth of water are the same.

In the illustrated embodiment, with the filter panel 110 folded over the tubular core 132, and with the cover 150 folded over the upper edge 116 of the folded filter panel 110 as shown in FIG. 1. The filter panel 110 and cover 150 have nested folds. Any tensile line passed through the interior channel 134 is effectively disposed under and along the folds of the filter panel 110 and cover 150 for a stable and secure construction.

As shown in FIG. 2, the filter panel 110 has multiple parallel sections 120 defined between parallel vertically extending slits 122 formed from the lower edge 124 of the panel 110 to an extent below the buoyant member 130, with the slits terminating without reaching the buoyant member. In the hanging arrangement of FIGS. 1-4, the sections 120 hang downward, for example into any body of water into which the filter assembly 100 is deployed. This arrangement of slits 122 between finger-like sections 120 facilitates self-cleaning of the filter panel 110 by slight relative motion among the finger-like sections 120, for example, as the sections 120 scour each other. Furthermore, in high-flow situations, the sections 120 permit the filter panel 110 to open to some degree to release flow pressure and decrease the likelihood of damage or loss when storm swells and other fast water incidents occur.

The width of each section 120 across the width 104 of a filter panel 110 can vary with various embodiments. The thickness of each layer 112 and 114 and thus the thickness 106 overall of the filter panel 110 can vary as well with various embodiments. Some degree of resistance against gentle flow conditions is desired so as to moderate or dampen rapidly changing flow conditions which may otherwise disturb settled sediments into a body of water under treatment. Thus, in at least one embodiment, the width of each section 120 and thickness 106 are selected to provide a fitter panel 110 that is semi-rigid and holds a generally planar form in still and mild flow conditions.

Low-density refers to materials having sufficiently low density to result in buoyancy of the buoyant member 130 in water. In typical use, the buoyant member 130 will generally float along the surface of a body of water and the filter panel 110 will hang in the water below the buoyant member 130. An expanding foam may be injected into any gaps or openings between components of the filter assembly 100 to further promote top-end buoyancy and/or to exclude water from entering.

As illustrated for example in FIGS. 3 and 4, one or more filter assemblies 100 can be deployed into and across a body of water 200, with the buoyant member 130 generally floating horizontally along the surface of the water and each filter panel section 120 hanging vertically in the water below the buoyant member 130. That is, FIGS. 3 and 4 represent various embodiments in which several filter assemblies are combined laterally end to end to have a combined width that crosses the body of water 200, which may be a flowing waterway, and embodiments in which a single filter assembly 100 has a width 104 (FIG. 2) sufficient to cross the body of water.

As shown in FIG. 3, the depth to which each filter panel 110 extends may be varied, for example with multiple filter panels 110 and/or sections 120 adjusted in the length 104 dimension (FIGS. 1-2) to match the contour of the bottom of the body of water 200. A filter assembly 100 can be cut and/or multiple filter assemblies 100 can be combined to any desired width 102 dimension, with the ultimate ends of such an assembly connected to fixed structures 160 to retain a desired arrangement. One or more tethers or tensile lines 162 can be passed through the interior channels 134 of one or multiple filter assemblies 100, with ends of the lines 162 extending from longitudinal ends of the assembly for attachment to the fixed structures 160 to anchor or fix the arrangement. A tensile line in these descriptions can include one or more of, without being limited to: a rope, cord, cable, chain, wire, a column, a rod, and a fibrous line.

One or more filter assemblies 100 can be deployed across the width of a storm water holding pond such that inlet water passes therethrough. In another embodiment, one or more filter assemblies 100 are deployed across an inlet plume of a large pond and lake, and/or in a stream feeding a larger body of water. Many configuration strategies are contemplated in various situations.

A filter assembly 100 according to at least one embodiment is affixed or anchored at one longitudinal end and rotates by allowing or causing the opposite end to move, for example in sweeping or circular paths around the fixed end. Thus, the filter assembly may move through the water, thereby enhancing mass transfer. Such an arrangement may be particularly useful in a body of water with little water movement. Similarly, a medial point of the filter assembly may be fixed such that the filter assembly is caused or allowed to rotate at any point between its two longitudinal ends. In some circumstances, the filter may be deployed without being anchored and allowed to move about the water body unconstrained. In such embodiments, the buoyant member provides movement via wind energy, or the buoyant member may incorporate an auxiliary wind catching device to provide locomotion. Various strategies to maximize the area swept by the filter relative to restrictions imposed by the individual site would be apparent.

In at least one embodiment, the width of each filter panel section 120 as defined by the distance between the slits 122 is great enough to avoid lateral side-to-side motion of the filter panel sections 120, with such motion being undesired in some uses. Dimensions are chosen so that the filter panel 110 maintains its neutral shape and position (FIGS. 1-2) by its own structural rigidity in still water and mild flows, but exhibits some flexing under forces applied by adverse conditions such as high or rapidly changing flow conditions. The filter panel 120 is resilient, returning to its neutral shape upon the cessation of the forces as adverse conditions subside.

The thickness 106 of the filter panel 110 can be selected, for example from one-quarter of an inch to several feet. In at least one example, multiple layers can be combined to any total thickness desired. In at least one particular example, each layer 112 and 114 is approximately 1.75 to 2.00 inches thick for a combined thickness 106 of the filter panel 110 of approximately 3.50 to 4.00 inches.

In at least one example, the filter panel 110 basic building block or stock material from which wider assemblies can be combined has a basic width 104 of approximately 5.00 feet. Furthermore, the length 102 of a filter panel 110 is considered with regard to rigidity because a longer filter panel 110 may less be able to hold its shape and position in flow conditions. Thus, a filter panel 110 having a length 102 of 50 feet, for example, may have no slits 122 and may be approximately 5.00 feet in width.

In at least one embodiment, the filter panel 110 is formed of nonwoven fibers. In at least one exemplary construction, a soft polymeric substrate is formed by random placement of fibers in a nonwoven pile. A binder is sprayed or otherwise applied to fix the substrate fibers relative to each other. As non-exhaustive examples, latex or styrene-butadiene rubber (SBR) can be used as a binder.

In at least one embodiment, the filter material is constructed using a blend of 300-500 Denier (den) polymeric fibers, referring to linear mass density. Fibers of other linear mass densities may be used. Fibers having lower linear mass densities are expected to result in filter constructions having higher effective surface areas, whereas higher linear mass density fibers correspond to more rigid and abrasive constructions. In some embodiments at least, the filter material is constructed using somewhat larger than 300 Denier (den) polymeric fibers. The diameters and/or Denier measure of the fibers used may be adjusted or selected based on expected waterborne solids load and/or the flow velocity.

At least one non-woven manufacturing process is expected to achieve single pile layer thicknesses of up to two inches. Thus, for example, a two-ply filter panel of three to four inches in thickness 106 in at least one embodiment is constructed from two layers. The filter material by virtue of the non-woven manufacturing process is designed to have interstitial spaces to facilitate mass transfer, while at the same time providing flow channels having a high degree of tortuosity such that passage of a particle through a filter assembly 100 is unlikely to occur without the particle colliding with the structure and being trapped or absorbed in biofilm. This is advantageous over, for example, a ceramic filter with micron size pores, which may quickly foul by the development of biofilm, even before a considerable quantity of target particles are collected. Filters constructed as described above with 300-500 Denier fibers have, on a relative basis, very large interstitial spaces and yet a high degree of tortuosity regarding any through path. Although flow channels may be large compared to, for example, those through a filter with micron size pores, a typical path through a filter according to embodiments described here is so convoluted that it is improbable that the smallest nano-sized colloidal particle can traverse the filter without bumping into the filter or biofilm and being captured via sorption into the biofilm. The design of the filter assembly 100 makes it useful for reducing total suspended solids (TSS), turbidity, and, for example, coliform bacteria.

Urbanization and concentrated agricultural activities result in increased levels of suspended solids and coliform bacteria in the world's water bodies. Remediation efforts of these issues include best management practices for storm water runoff. Filters as described herein may be used in any location in a body of water. In particular embodiments, one or more filter assemblies 100 are used synergistically with other best management practices.

Suspended solids, or colloidal particles, that do not settle to the bottom of water by gravity often contain coliform bacteria. High levels of suspended solids increase the turbidity of the water, thus restricting the depth that sunlight can penetrate. The filter assembly 100 can reduce TSS by capturing colloidal particles in the sticky EPS. The coliform bacteria contained in the colloidal particles may then be subject to predation or may be deposited into lower sediments in flocs generated by sloughing of the biofilm. The reduction in TSS results in reduction of turbidity. As the turbidity decreases, sunlight is much more efficient in killing coliform bacteria due to increased depth of penetration.

Total suspended solids can include both inorganic and organic particles that settle to the sediment via gravity. These larger particles often settle out of the water column at locations where fast moving streams carrying suspended solids lose velocity when merging into a larger body of water. The filter assembly is not merely intended to be a silt screen or a particle curtain, but is most effectively deployed just beyond the plume sediment footprint in this situation to filter colloidal particles and free cell bacteria. Thus, embodiments described herein are distinguished over screens/curtains/filters that are available to deal with sans/silt/large particles that will settle by themselves via gravity.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A filter assembly comprising:
a horizontally extending buoyant member; and
a filter panel that extends vertically from the buoyant member, the filter panel defining a tortuous path for passage of water and a surface area for biofilm growth and capture of particles in the biofilm, the filter panel being flexible from a neutral shape and position under force, and being resilient to return to the neutral shape and position by structural rigidity after cessation of the force.

2. A filter assembly according to claim 1, wherein the filter panel comprises multiple parallel sections defined between parallel vertically extending slits.

3. A filter assembly according to claim 2, wherein the parallel sections are flexible permitting opening of the slits

4. A filter assembly according to claim 2, wherein the filter panel comprises a distal end extending away from the buoyant member, and the slits extend from the distal end toward the buoyant member without reaching the buoyant member.

5. A filter assembly according to claim 1, wherein the filter panel comprises a first layer and a second layer that extend vertically in the same direction from the buoyant member.

6. A filter assembly according to claim 5, wherein the first layer and the second layer are contiguous portions of a single sheet of material that defines the filter panel.

7. A filter assembly according to claim 6, wherein the single sheet of material is uniformly thick.

8. A filter assembly according to claim 6, wherein the single sheet of material is folded over the buoyant member.

9. A filter assembly according to claim 1, further comprising a protective cover facing away from the buoyant member opposite a direction in which the filter panel extends from the buoyant member.

10. A filter assembly according to claim 9, wherein the filter panel is folded over the buoyant member and the cover is folded over the filter panel.

11. A filter assembly according to claim 10, wherein the filter panel has a fold, and the buoyant member has a fold that is nested with the fold of the filter panel.

12. A filter assembly according to claim 1, wherein the buoyant member comprises a tubular core surrounding an interior channel.

13. A filter assembly according to claim 12, further comprising a tensile line disposed within and along the interior channel.

14. A filter assembly according to claim 13, wherein the tensile line has at least one end attached to at least one fixed structure near a body of water.

15. A filter assembly according to claim 1, wherein the filter panel comprises multiple parallel sections defined between parallel vertically extending slits, and the multiple parallel sections vary in length as measured from the buoyant member.

16. A filter assembly according to claim 1, wherein the filter panel has a thickness of approximately 3.50 to 4.00 inches.

17. A filter assembly according to claim 16, wherein the filter panel has two layers, each having a thickness of approximately 1.75 to 2.00 inches.

18. A filter assembly according to claim 1, wherein the filter panel comprises a non-woven pile of fibers.

19. A filter assembly according to claim 18, wherein the filter panel comprises a material binding the fibers.

20. The apparatus of claim 18, wherein the fibers comprise 300-500 Denier (den) polymeric fibers.
